(19) United States
(12) Patent Application Publication
(10) Pub. No.: US 2008/0239431 A1
(43) Pub. Date: Oct. 2, 2008

(54) MICROMECHANICAL DEVICE OF INCREASED RIGIDITY

(75) Inventors: Thomas KLOSE, Dresden (DE); Christian DRABE, Dresden (DE)

Correspondence Address: SCHOPPE, ZIMMERMAN , STOCKELLER & ZINKLER;C/O KEATING & BENNETT , LLP, 1800 Alexander Bell Drive, SUITE 200, Reston, VA, 20191, US

(73) Assignee: Fraunhofer-Gesellschaft zur Forderung der angewandten Forschung e.V., Munich (DE)

(21) Appl. No.: 12/046,657

(22) Filed: Mar. 12, 2008

(30) Foreign Application Priority Data
Apr. 2, 2007 (DE) 10 2007 015 718.7
Oct. 30, 2007 (DE) 10 2007 051 820.1

(51) Int. Cl. G02B 26/08

(52) U.S. Cl. 359/198

(57) ABSTRACT

A micromechanical device includes a deflectable micromechanical functional structure and a non-rigid biased suspension positioning the micromechanical functional structure in the micromechanical device.

### CROSS-REFERENCE TO RELATED APPLICATIONS

This application claims priority from German Patent Application No. 102007015718.7, which was filed on Apr. 2, 2007, and German Patent Application No. 102007051820.1, which was filed on Oct. 30, 2007, which are both incorporated herein in their entirety by reference.

### TECHNICAL FIELD

The invention relates to a micromechanical device in which the rigidity is increased and, in particular, to a micromirror comprising an electrostatic comb drive of increased rigidity.

### BACKGROUND

In micromechanical micromirrors, a mirror plate suspended on torsion springs is deflected around one or two axes, depending on whether this is a one- or two-dimensional scanner mirror. Deflection driving may exemplarily be realized by electrodes arranged in the shape of combs, the electrodes being formed in the substrate plane of the micromechanical device. Such scanner mirrors are, for example, described in the doctoral thesis by H. Schenk “Ein neuartiger Mikroaktor zur ein-und zweidimensionalen Ablenkung von Licht”. The advantages of this principle are the comparatively simple manufacturing and high drive efficiency. Alternatively, the electrode geometry may additionally be structured in height so that the result is a three-dimensional assembly, as is illustrated in the dissertation by Ch. Porth (“Untersuchung von nichtresonanten Antriebsprinzipien für Mikroscannerspiegel zur niederfrequenten bzw. quasistatischen Lichtablenkung”, Diplomarbeit 2006, TU Dresden).

Potential electromechanical instabilities occurring are a basic disadvantage of the electrostatic drive. These may occur both in normal operation of an electrode assembly, as is described by J. Mehner in “Entwurf in der Mikrosystemtechnik”, Dresden University Press, 1999 and by T. Kieβling et al. in “Bulk micro machined quasistatic torsional micro mirror”, in Proceedings of SPIE, MOEMS and Miniaturized Systems, 2004, and in undesired deflections, due to parasitic electrostatic forces and torques. A prerequisite for an electromechanically instable behavior is an electrostatic moment or force which increases faster in a deflection direction than the mechanical restoring moments of the torsion springs. The result of such a situation is the so-called pull-in effect. It may result in an uncontrolled increase in deflection and, if not restricted by suitable structures, like, for example, by defined stops, this behavior may result in a collision of the electrodes of the electrostatic drive. This, in turn, may cause the device to be destroyed and should be avoided absolutely.

Due to the mode of operation of micromirrors including an electrostatic comb drive, pull-in effects cannot arise in the useful direction when tilting the mirror plate and/or the movable frame. The parasitic electrostatic moments effective in an electrode assembly, however, may even here result in an undesired deflection and also in a pull-in effect. This case may occur when such a moment acts in the direction of a parasitic mechanical degree of freedom of the micromirror. This may exemplarily be the rotation of the micromirror within the plane or even translation of the micromirror within the plane. The parasitic electrostatic moments of a micromirror including an electrostatic comb drive result from the fact that the capacitance of the electrode assembly does not vary exclusively when deflected in the degrees of freedom used, i.e. as a tilting movement out of the plane. Exemplarily, slight rotation of the mirror plate around an axis through the mirror plate normal or translation of the mirror plate within the structural plane may result in a change in capacitance. The result may be an electrostatic force and/or electrostatic torque which may result in pull-in.

In order to avoid pull-in, the increase in the restoring mechanical moments and/or forces made by the suspension, i.e. the torsion springs, in the rest position of the scanner needs to have a greater magnitude than that of the electrostatic moment. If this condition is not fulfilled, the equilibrium in the rest position will become unstable. Arbitrarily small disturbances may result in an increase in deflection and thus in pull-in.

The voltage where the equilibrium of moments is just becoming unstable is also referred to as stability voltage or pull-in voltage. It is an important operating parameter of a micromirror including an electrostatic comb drive. Apart from the dielectric strength of the insulations, the electrical stability voltage of a device is a limiting factor for the electrical drive voltage and thus for the deflection.

Increasing the lateral mechanical resistance by making the torsion springs on which the micromirror is suspended wider or shorter is not an option in many cases, since they are also influenced in their torsion spring hardness by such measures. In resonant devices, the resonant frequency would change by this. For quasi-static deflectable devices, the forces and/or moments to be applied by the drive would increase, which, in turn, results in a great area consumption of the drive and/or a higher power consumption. This is not realizable nor acceptable for many applications. An easy way of increasing the mechanical resistance of a suspension including torsion springs is optimizing the points of application of the springs on the deflectable structure. The deflectable structure may exemplarily be a mirror plate or also a movable frame in a two-dimensional scanner. At least the pull-in effect resulting from the rotational degree of freedom of the scanner within the structural plane may be influenced in this manner. In order to achieve the greatest stability possible, the points of application of the springs should be arranged as far away from the fulcrum of the parasitic movement as possible. Due to the leverage, the restoring mechanical torque will then increase.

A disadvantage of this approach of a solution is an increased area consumption of the device since the points of application of the spring structures are to be arranged as far from the fulcrum of the parasitic movement as possible. In addition, only the parasitic rotational degree of freedom, i.e. the rotation within the structural plane, can be influenced.

In EP 1 338 553 A2, another approach for a solution is suggested. This approach is based on the idea of additionally structuring a straight torsion spring. If it is implemented in a kind of lattice structure, the lateral rigidity can be increased at constant torsion spring hardness.

What is sought is a way of increasing the lateral mechanical resistance without strongly influencing, like, for example, increasing, the torsion spring hardness of the degree of freedom used.

### SUMMARY

According to an embodiment, a micromechanical device may have a deflectable micromechanical functional structure and a non-rigid biased suspension which positions the micromechanical functional structure in the micromechanical device.

### BRIEF DESCRIPTION OF THE DRAWINGS

Embodiments of the present invention will be detailed subsequently referring to the appended drawings, in which:

FIG. 1 is a top view representation of a micromirror suspended on torsion springs including respective comb electrodes and the pull-in effect resulting from the rotational degree of freedom of the mirror plate;

FIG. 2 is a diagram of the parasitic torque in the direction of the normal of the structural plane of a mirror plate and the respective mechanical degree of freedom;

FIG. 3 is a top view representation of a micromechanical device of increased rigidity according to an embodiment of the present invention;

FIG. 4 is a basic sketch of a suspension including a biased torsion spring according to an embodiment of the present invention;

FIG. 5 is a basic sketch of a suspension including a torsion spring biased by intrinsic tensile stress according to another embodiment;

FIG. 6 shows another embodiment of the present invention, where the biasing of the suspension is realized by introducing intrinsic compressive stress within a chip frame;

FIG. 7 shows another embodiment of the present invention, where the biasing is realized by an intrinsic tensile stress within the deflectable structure;

FIG. 8 shows another embodiment of the present invention, where the biasing of the torsion spring is realized by a structure including an impressed stress gradient;

FIG. 9 is a representation of torsion springs according to an embodiment of the present invention, where the intrinsic tensile stress is realized in the torsion springs themselves;

FIG. 10 shows an embodiment of a structure manufactured in silicon including intrinsic tensile stress;

FIG. 11 shows another embodiment for generating intrinsic tensile stress in a silicon/silicon nitride layer;

FIG. 12 is a cross-sectional representation of a structure including silicon dioxide, silicon/silicon nitride, by means of which a stress gradient can be generated within this structure, according to an embodiment of the invention;

FIG. 13 is a cross-sectional representation of a structure including an unsymmetrical arrangement of material for generating intrinsic compressive stress; and

FIG. 14 shows another embodiment of the present invention, where the necessary force for biasing the torsion springs may also be generated actively, for example by an electrostatic comb drive.

### DETAILED DESCRIPTION

According to embodiments of the invention, torsion springs are provided with a force at their ends so that the structures are stressed in parallel to the torsion axis. The mechanical tensile stress forming in the springs results in a strong increase in the lateral rigidity. The basic principle thus corresponds to tightening a guitar string. The torsion spring hardness here is hardly changed or increased only slightly. The necessary forces for realizing this idea at the ends of the springs may be realized by specifically introducing intrinsic material stress, alternatively even by an additional actor which exemplarily operates in accordance with the electrostatic, piezoelectric, magnetic, thermal, magnetorestrictive or another corresponding principle.

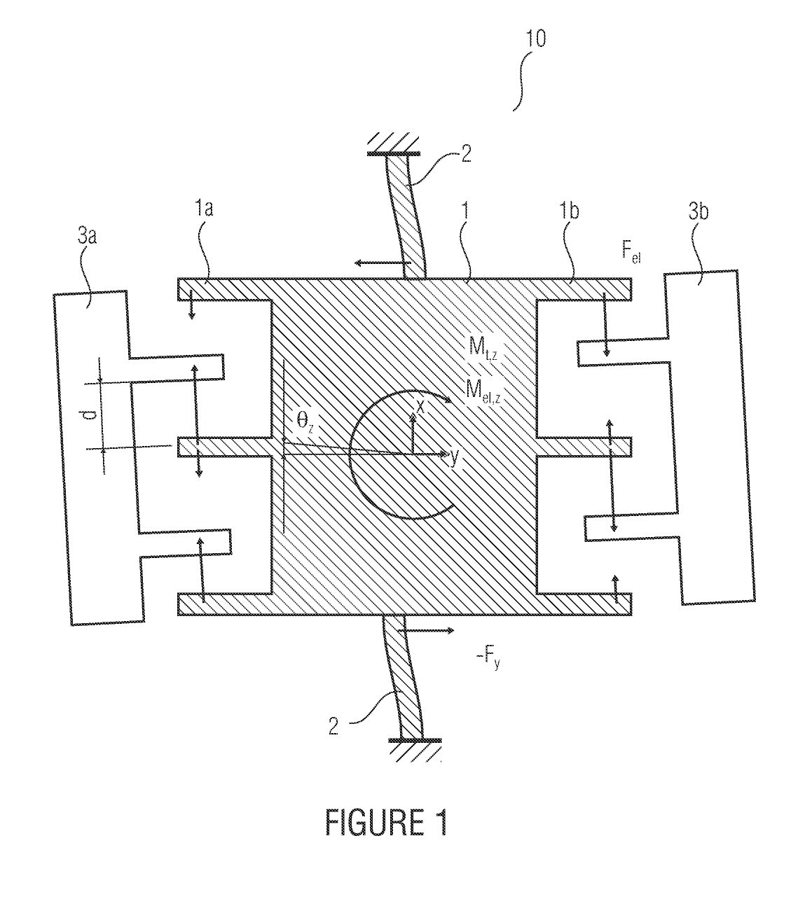

A setup of a one-dimensional scanner mirror including an electrostatic drive and the occurrence of undesired rotational deflection which may result in a pull-in effect are illustrated at first in FIG. 1. The scanner mirror 10 comprises a mirror plate 1 on the sides of which electrode combs 1a and 1b are applied which are necessary for the electrostatic drive. The mirror plate 1 is suspended via torsion springs 2 and positioned such that the fingers of the electrode combs 1a and 1b will engage the fingers of the counter electrode combs 3a and 3b such that the fingers have a constant spacing d under normal conditions. The functionality of the scanner mirror is based on the fact that applying a voltage to the electrodes generates the mirror plate to be rotated around the torsion axis which is formed by the two torsion springs 2 applied in the center. The result of twisting the springs is a mechanical restoring moment which increases proportionally to the angle of deflection of the plate and counteracts the electrostatic torque generated by a voltage between the electrode combs 1a, 1b and 3a, 3b.

It is shown in FIG. 1 that, with an electrostatic drive, electromechanical instabilities may form which may occur both in normal operation and also by undesired deflection due to parasitic electrostatic forces and torques. A prerequisite for an electromechanically unstable behavior is an electrostatic moment or force Fₑₗ which increases faster in a direction of deflection than the mechanical restoring moments and/or restoring forces −F_{y}. The result of such a situation may be the so-called pull-in effect which may result in an uncontrolled increase in deflection. This may even result in a collision of the electrodes 1a, 3a and/or 1b, 3b. This case may, for example, arise when such a parasitic moment acts in the direction of a mechanical degree of freedom of the micromirror 1. In FIG. 1, this is, for example, rotation around the z axis constituting the normal to the xy plane where the mirror plate 1 is arranged. The parasitic electrostatic moments of a micromirror including an electrostatic comb drive result from the fact that the capacitance of the electrode assembly does not vary exclusively when deflected in the degrees of freedom used, i.e. tilting movement out of the plane. Rotation around the z axis as shown or translation within the structural plane (xy plane), for example, results in a change in capacitance. The result here is an electrostatic force and/or an electrostatic torque M_{el,z} which may result in pull-in.

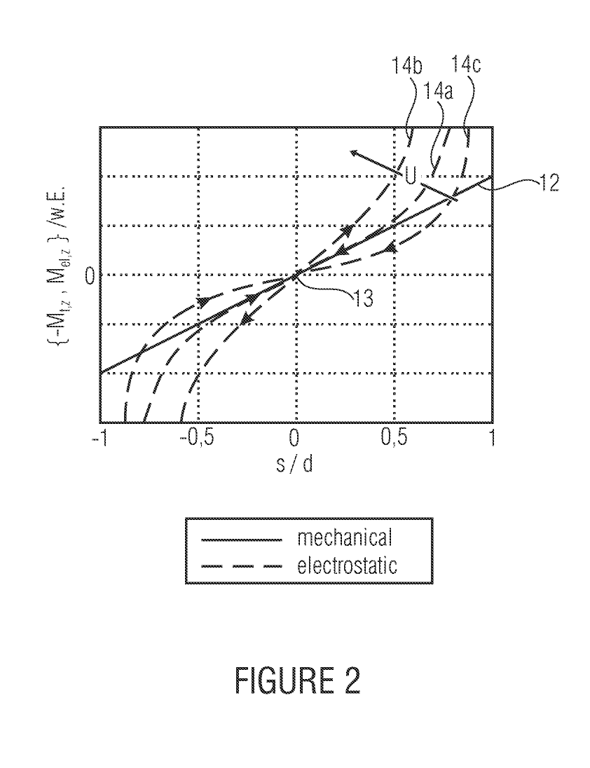

This connection is illustrated in FIG. 2 using the example of a parasitic torque in the direction of the normal of the structural plane and the respective mechanical degree of freedom.

The restoring mechanical torque M_{t,z} and the electrostatic torque M_{el,z} in FIG. 2 are plotted on the abscissa of the diagram in arbitrary units. The ratio of the deflection s to the normal spacing d of the fingers of the comb electrodes is plotted on the x axis. If there is no parasitic electrostatic torque and thus no deflection, s will take a value of zero, and thus the ratio of s and d also, which is expressed in the diagram by the rest position 13. As can be seen from FIG. 2, the restoring mechanical torque which is represented by graph 12 has a linear behavior with regard to deflection. The electrostatic moments represented by the graphs 14a to 14c depend on the voltage applied between the electrode combs and do not exhibit a linear behavior. This means that when the increase in the electrostatic moment in the rest position is greater than the restoring mechanical moment, the result may be an increase in deflection, and thus pull-in. The voltage where the equilibrium of moments is just becoming unstable is also referred to as stability voltage or pull-in voltage. It is an important operating parameter of a micromirror including an electrostatic comb drive. Apart from the electrical dielectric strength of the insulations used in scanner mirrors (not shown in the figure), the stability voltage of a device is a limiting factor for the drive voltage, and thus the deflection of a scanner mirror.

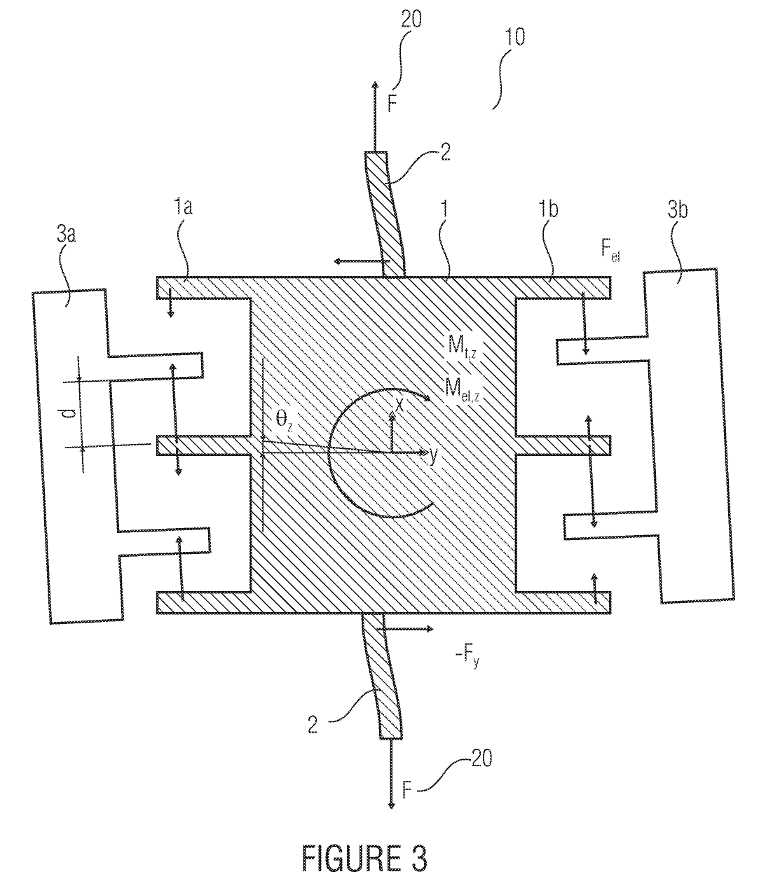

FIG. 3 shows the principle of a micromechanical device of increased rigidity using a microscanner mirror 10 whose mirror plate 1 and the electrode combs 1a and 1b are suspended on torsion springs 2 so that in normal operation the fingers of the electrode combs 1a and 1b have a defined spacing d to the fingers of the electrode combs 3a and 3b. FIG. 3 shows that, by providing the torsion springs with a force 20 at the spring ends, the mirror plate 1 and the torsion springs can be stressed in the direction of the torsion axis. The mechanical tensile stress forming in the torsion springs 1 results in a strong increase in the lateral rigidity, corresponding to the principle of tightening a guitar string. The torsion spring hardness which is determined for the rotation of the mirror plate around the torsion axis which is formed by the two torsion springs disposed in the center is hardly changed at all or only increased slightly. By biasing the torsion springs 2, an increased mechanical moment counteracting the electrostatic moments can be achieved in the device and/or scanner mirror. The necessary forces for realizing suspension biasing at the ends of the torsion springs may be realized by specifically introducing intrinsic material stress, but alternatively also by an additional actor.

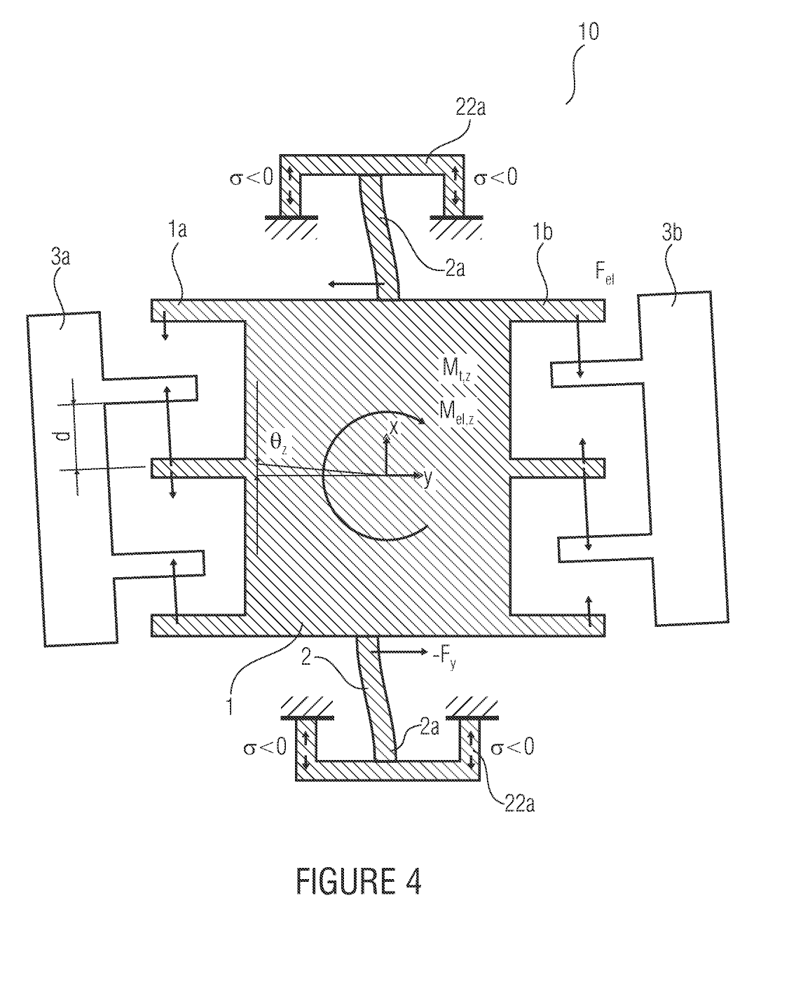

FIG. 4 shows an embodiment of the present invention in a basic sketch. The one-dimensional scanner mirror 10 already described comprises, at the ends of the torsion springs 2a, self-supporting structures 22a leading to the torsion springs 2, by means of which tensile stress can be introduced specifically into the torsion springs 2. This means that, in this embodiment, the torsion springs 2 are biased by tensile stress which is caused by the intrinsic compressive stress (σ<0) introduced into the self-supporting structure 22a. The torsion springs biased in this way comprise an increased mechanical restoring moment relative to parasitic moments. The mirror plate 1 comprising the biased torsion springs 2 of the scanner mirror 10 thus has increased rigidity relative to the parasitic rotary and translatory movements.

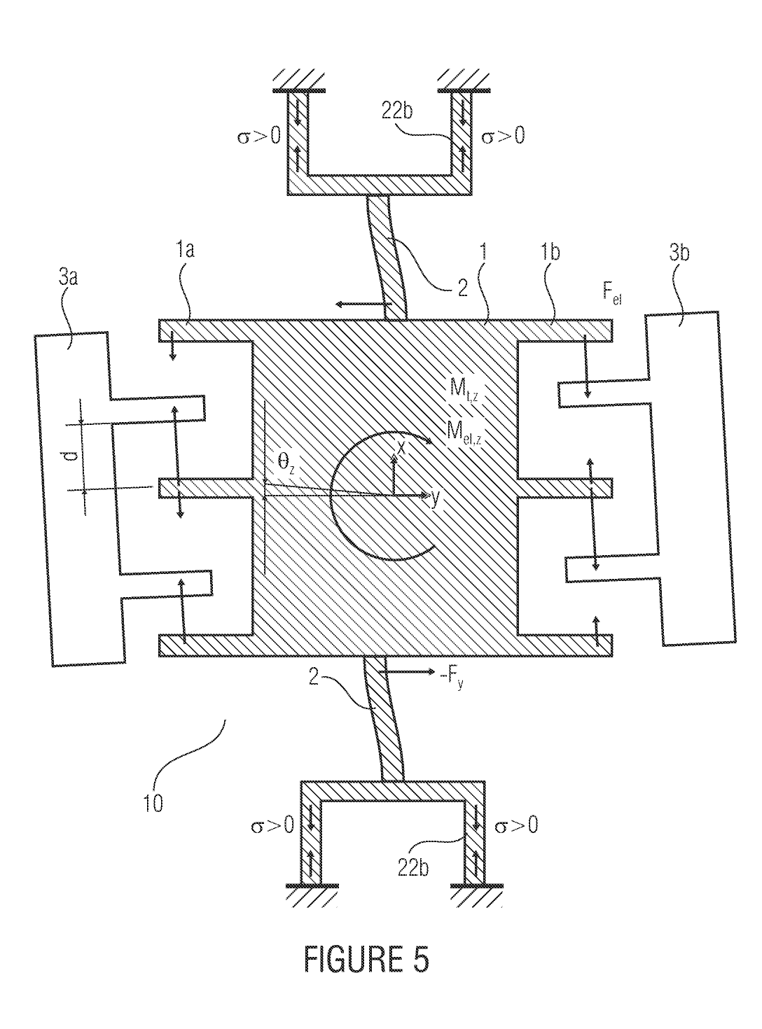

Another way of biasing the torsion springs 2 for the scanner mirror 10 is illustrated in FIG. 5. In this embodiment, suspension with a biased torsion spring is realized be specifically introducing intrinsic tensile stress (σ>0) within self-supporting structures 22b leading into the torsion springs 2. Like in the previous example, the structures 22b are able to generate tensile stress in the torsion springs. This, in turn, results in an increased mechanical restoring moment relative to parasitic electrostatic torques or other forces and torques which disturb the positioning of the fingers of the electrode combs 1a and 1b between the fingers of the counter electrodes 3a and 3b. The torsion spring hardness for the rotation of the mirror plate 1 around the rotational axis formed by the torsion springs 2 here is hardly changed or only changed slightly, like, for example, increased slightly.

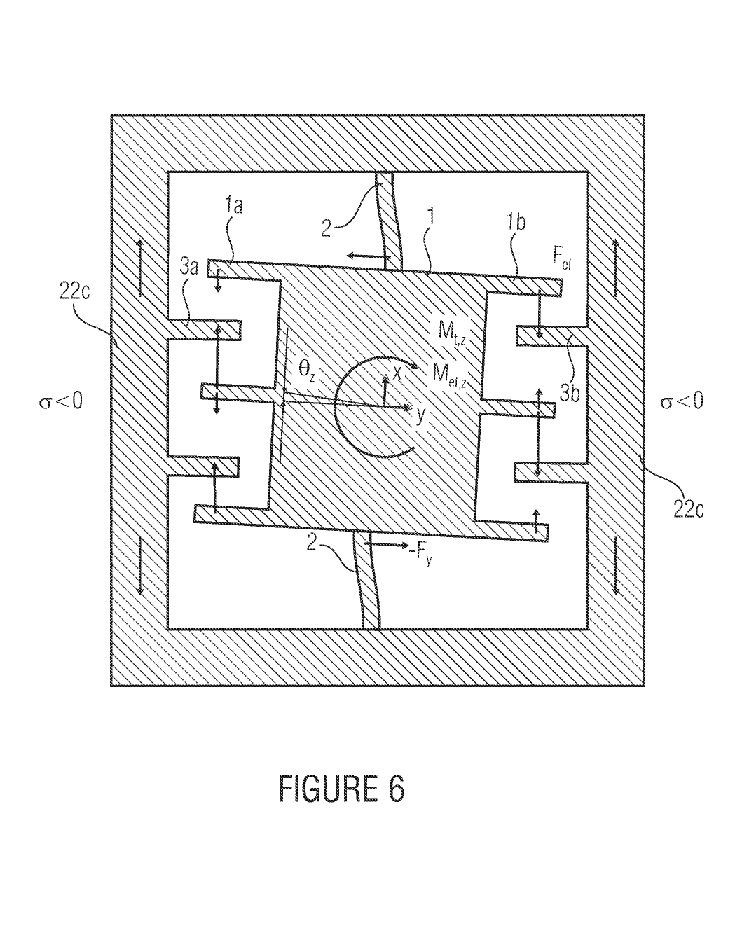

FIG. 6 shows another embodiment of the present invention. The biasing of the torsion springs 2 in this embodiment is realized by introducing intrinsic compressive stress (σ<0) within a chip frame 22c in which the mirror plate is suspended via the torsion springs 2. In this embodiment, torsion spring biasing is achieved by structures which are usually components of the scanner mirror. The compressive stress generated in the chip frame 22c causes the torsion springs 2 to be biased, which, in turn, results in the increased rigidity of the mirror plate mentioned before relative to rotary or translatory torques or forces.

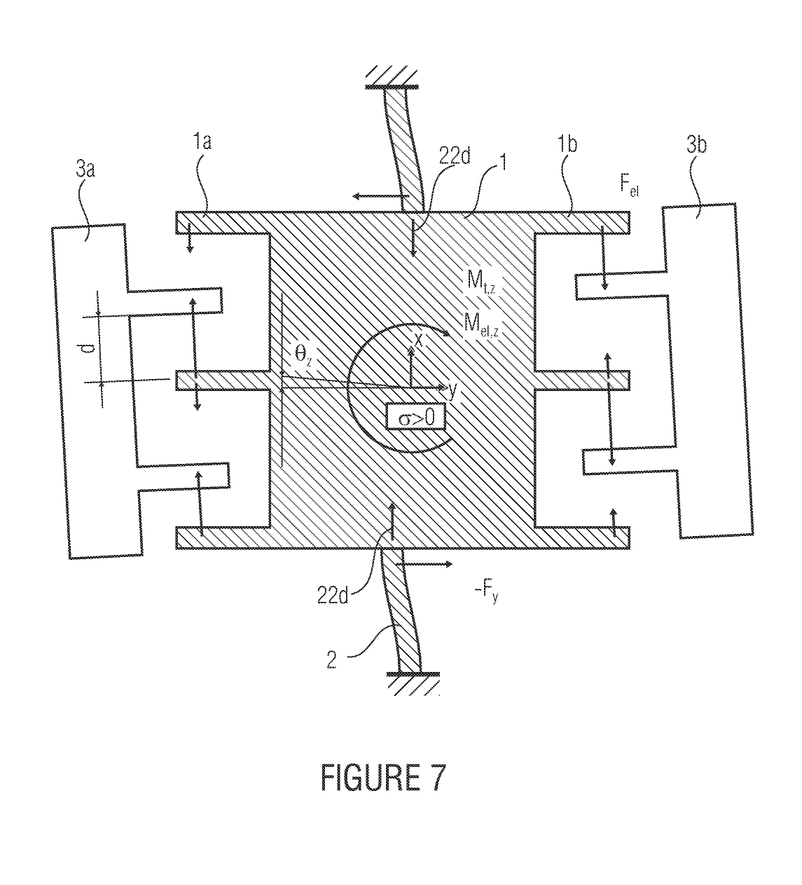

FIG. 7 includes another embodiment of the present invention where the biasing of the torsion springs 2 is realized by intrinsic tensile stress (σ>0), indicated in the figure by arrows 22d, within the mirror plate 1. This intrinsic tensile stress in turn results in the torsion springs 2 to be biased, whereby their lateral rigidity can be increased.

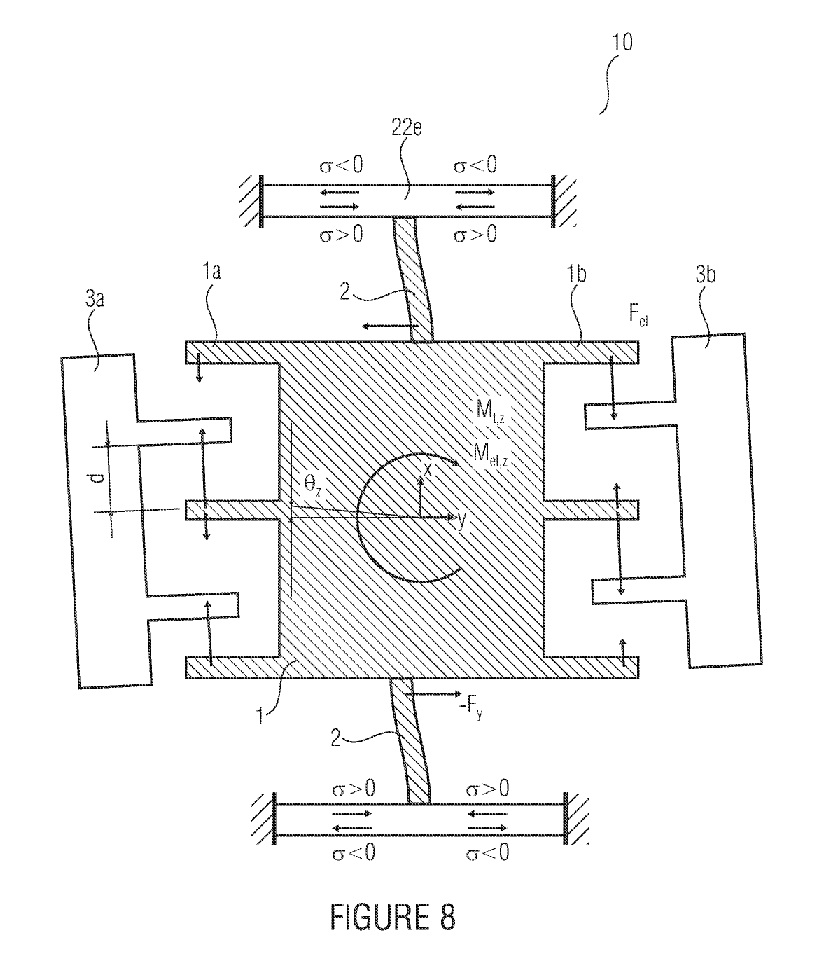

FIG. 8 shows another embodiment of the present invention, where the biasing of the torsion springs is achieved by means of tensile strain acting on the torsion springs. This tensile strain can be obtained by a structure 22e comprising an impressed mechanical stress gradient which results in an intrinsic bending moment of the structure 22e. This means that the necessary tensile stress for biasing the torsion springs 2 is realized by the intrinsic bending moment of the structure 22e.

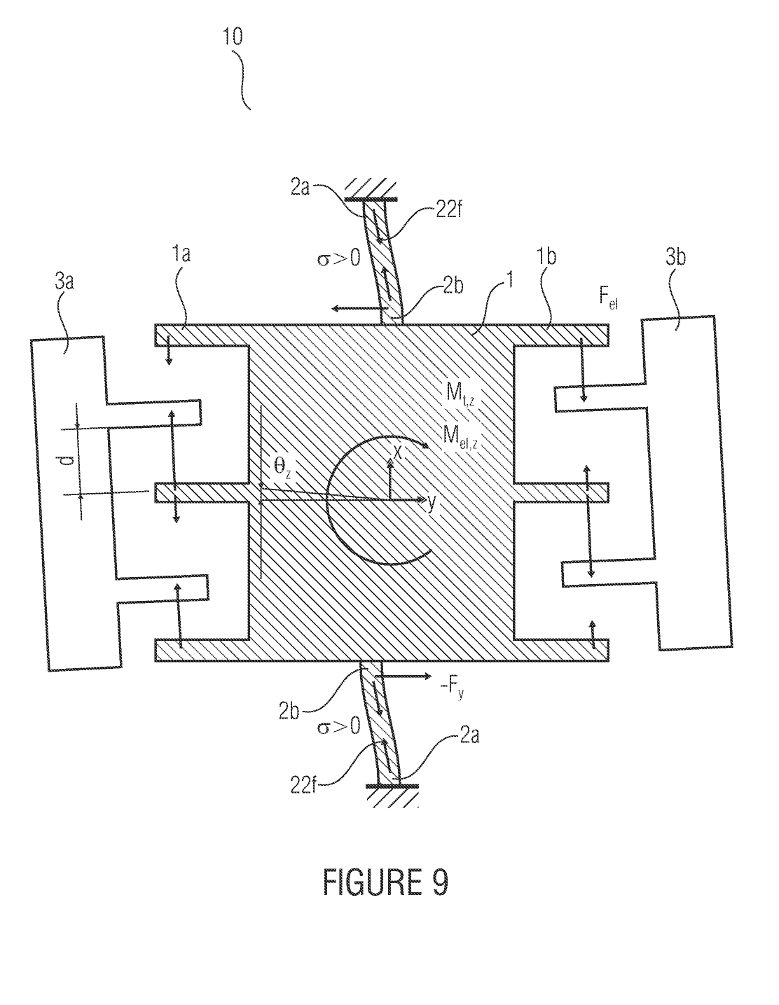

An example where the intrinsic tensile stress (σ>0) is realized in the torsion springs themselves is shown in FIG. 9 as another embodiment of the present invention of a micromechanical device of increased rigidity. This means that the torsion springs can comprise intrinsic tensile stress due to their qualities, which also results in tensile forces at the spring ends 2a and 2b, which in turn results in an improved lateral rigidity and thus an increased restoring mechanical moment relative to parasitic electrostatic or mechanical torques.

It is conceivable for a tensile force to be applied only to one torsion spring and/or one side of the suspension in the embodiments illustrated before. Also, combinations of different embodiments are conceivable and realizable. Exemplarily, tensile stress may be in the deflectable structure and compressive stress in the corresponding chip frame. In the micromechanical device according to the invention, this may exemplarily be a structure manufactured in silicon or another semiconductor material. It is also conceivable to use different spring shapes, as are exemplarily described in the patent application PCT/DE2006/000746.

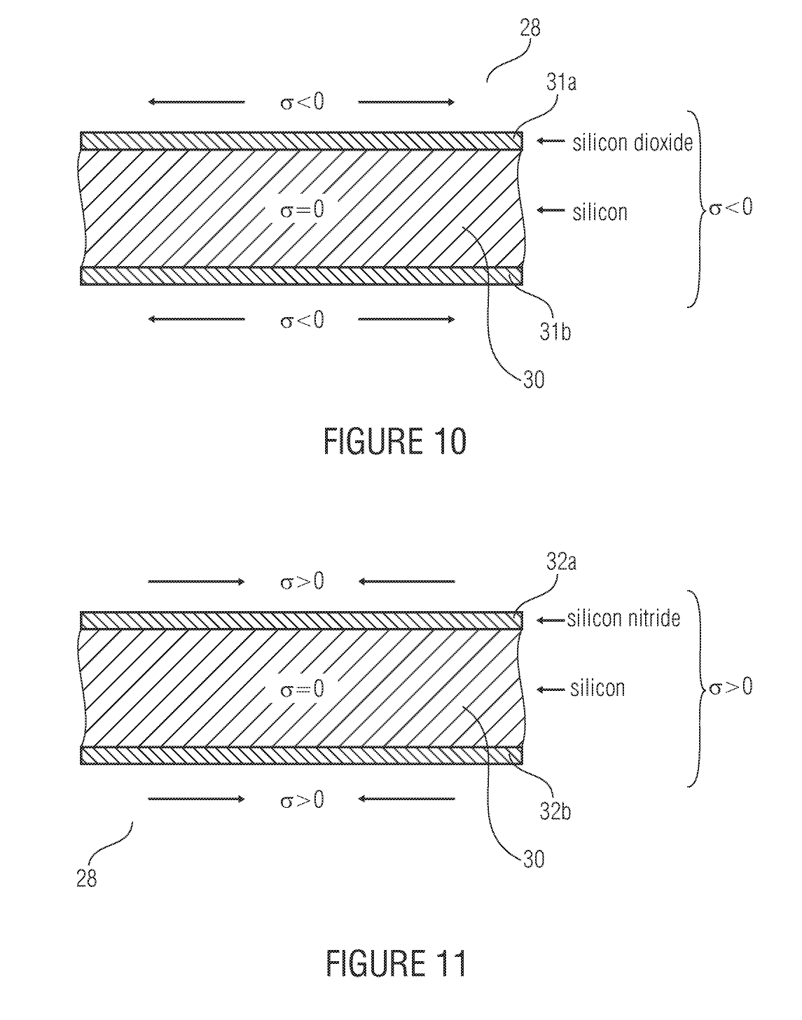

One way of introducing intrinsic mechanical stress, as illustrated in the above embodiments, into a structure manufactured in silicon is exemplarily illustrated in FIG. 10. By partly or completely oxidizing a structure 28, a layer system including silicon 30 and silicon dioxide 31a, 31b can be generated. In the example illustrated, the silicon 30 does not have intrinsic stress, which is why σ=0, whereas the two silicon dioxide layers 31a, 31b above and below the silicon layer 30 have an intrinsic compressive stress of σ<0. The structure 28 which is based on silicon thus has a resulting intrinsic compressive stress σ<0.

FIG. 11 shows another way of introducing intrinsic mechanical tensile stress into a structure manufactured in silicon. In this embodiment, a silicon nitride layer 32a and/or 32b may be applied to a silicon structure 30 so that, as is illustrated in FIG. 11, the entire structure 28 has an intrinsic tensile stress of σ>0. In this embodiment, the silicon nitride layer 32a and 32b has an intrinsic tensile stress of σ>0 relative to the silicon layer of σ=0, which is why an intrinsic overall tensile stress of σ>0 results for the structure 28.

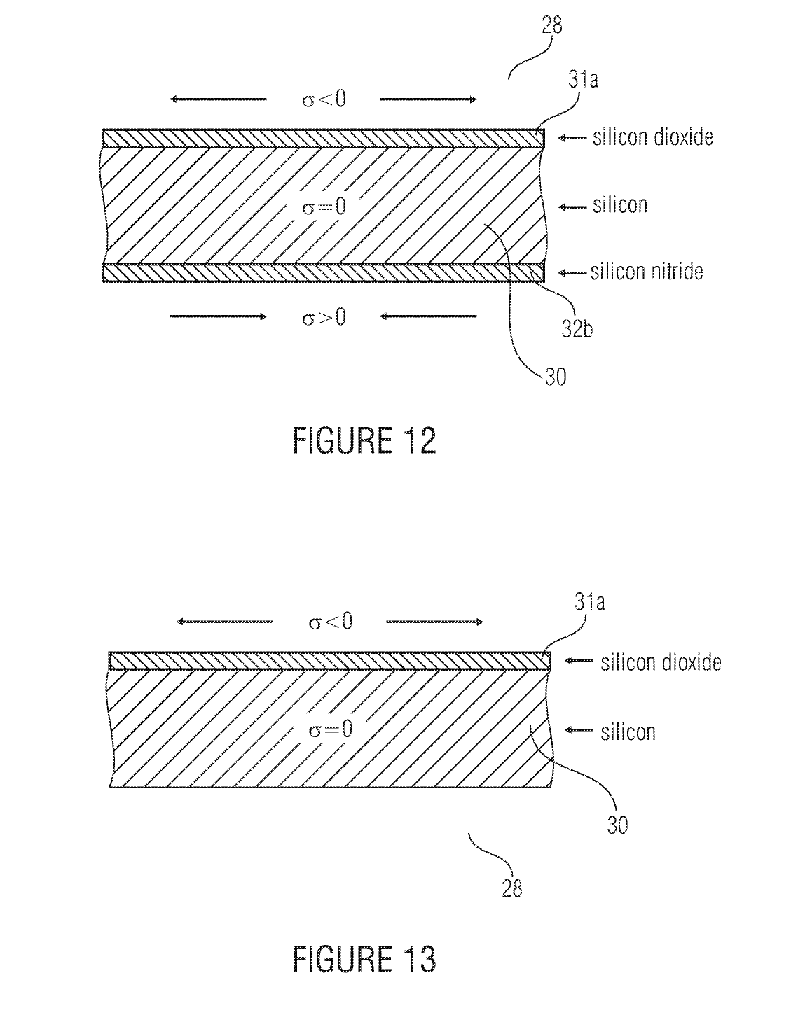

As is illustrated in FIG. 12, a mechanical stress gradient within a silicon structure may exemplarily be realized by a combination of the methods for generating compressive and tensile stress. In this embodiment, a silicon layer 30 which has no intrinsic mechanical stress whatsoever (σ=0) is oxidized on the top of the structure so that a silicon dioxide layer 31a having an intrinsic compressive stress (σ<0) results. A silicon nitride layer 32b having an intrinsic tensile stress (σ=0) may then exemplarily be deposited on the bottom of the structure. The result of this combination of layers is a mechanical stress gradient within the structure 28.

As is shown in another embodiment in FIG. 13, an unsymmetrical arrangement of the respective materials within the layer system and/or structure 28 is also conceivable. As is shown in FIG. 13, only one side of the silicon layer 30 may exemplarily comprise a silicon dioxide layer 31a. Due to the intrinsic compressive stress of the silicon dioxide layer, a stress gradient results for the entire structure 28.

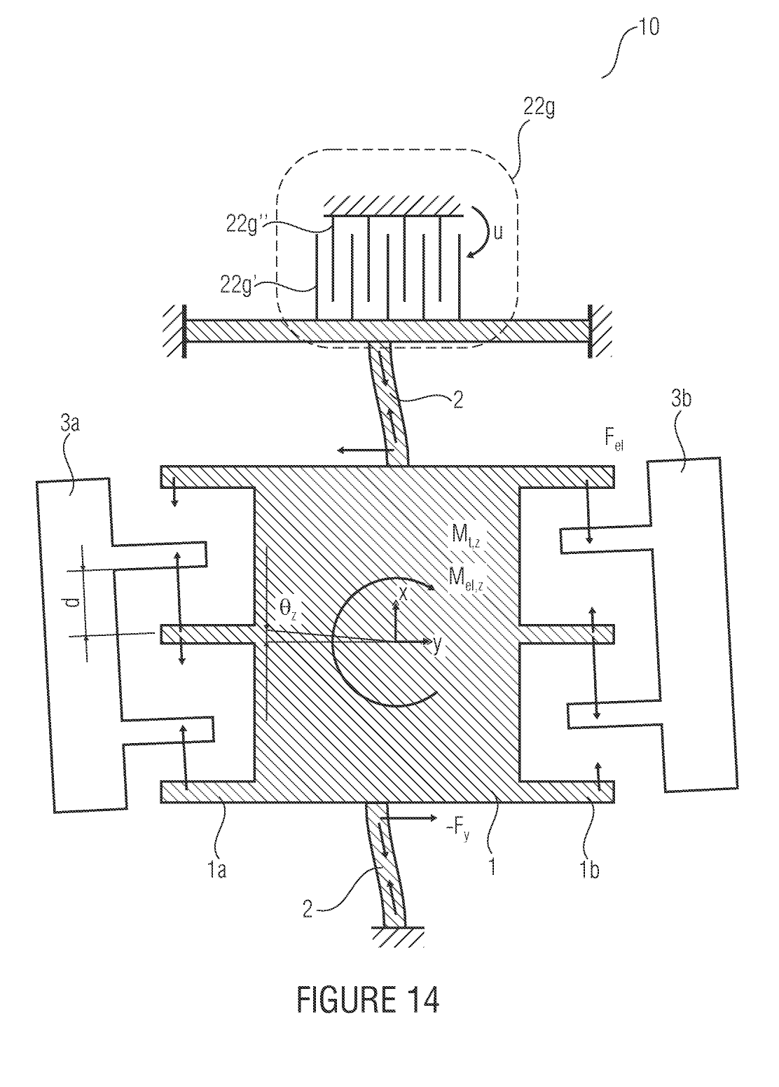

A further embodiment of the present invention is illustrated in FIG. 14. In this embodiment, the necessary force for biasing the torsion springs 2 is generated actively. In the embodiment, the necessary force for biasing is generated by an electrostatic comb drive 22g which can generate a force when a suitable voltage is applied between the two comb electrodes 22g′, 22g″. Such a comb drive and/or general actor may exemplarily also be formed within the deflectable mirror plate. In addition, using a combination of both variations is also conceivable. Instead of the electrostatic comb drive 22g, other actors having, for example, a piezoelectric, magnetic, thermal or other physical-chemical drive principle may also be used.

Biasing the suspension and/or torsion springs may take place using an actor introducing tensile stress into the geometry of the micromechanical device, wherein the drive structure (actor) may then be locked. In this way, biasing can be enabled at any time. However, after locking no more driving is necessary to maintain the state. If the drive structure is not locked, the biasing by the actor may be set arbitrarily and may even be changed.

In addition, both an intrinsic biasing and active biasing of the springs and/or suspension may be realized by taking measures when mechanically setting up the device, like, for example, by introducing intrinsic tensile stress in the casing of the device or by mounting the device on a deflectable substrate, like, for example, a piezoelectric crystal.

The micromechanical device may exemplarily correspond to the systems mentioned in the embodiments including mirror plate and torsion spring, wherein the deflectable micromechanical functional structure may represent the mirror plate and the non-rigid biased suspension may represent the biased torsion springs which in the embodiments position the mirror plate with its electrode combs.

Further ways of applying micromechanical devices including a biased suspension and/or biased torsion springs can exemplarily be found in the field of data acquisition, i.e., for example, one-dimensional, two-dimensional scanners, or also in the field of microscopy. Other fields of application are in the fields of data output for laser displays, laser printers, laser exposers, etc. Using micromechanical devices including biased suspension is, for example, also conceivable in the field of light path manipulation for optical apparatuses, like, for example, Fourier spectrometers, path way modulation or other optical apparatuses. Using micromechanical devices including biased torsion springs in pressure, acceleration or viscosity sensors is also possible.

The micromechanical device and the deflectable micromechanical functional structure arranged therein need not be an optical functional structure or mirror plate. The rigidity of the non-rigid biased suspension is not only increased laterally, but also perpendicularly to the plane where the suspension is applied. This may exemplarily also be used for increasing shock resistance and/or resistance to impacts to devices where the suspended structure may, for example, hit the lid or bottom of a casing when dropped.

It is also conceivable to specifically influence the mechanical natural frequencies of the micromechanical structure using the biased suspension and/or torsion springs so that exemplarily the splitting of vibrational modes of the micromechanical functional structure can be improved. For clarification purposes, it is pointed out that the micromechanical functional structure with its suspension may represent a vibratable mechanical spring mass system attenuated by friction. The functionality of the optical functional structure may, in the case of the mirror plate of the scanner, is based on the rotation of the mirror plate around the torsion axis which is formed by the two torsion springs disposed in the center. A mechanical restoring moment which increases proportionally to the deflection angle of the plate is formed by twisting the springs. This system thus is a harmonic oscillator including corresponding natural frequencies and stable modes.

The micromechanical device according to the present invention may exemplarily be a resonant or non-resonant microsystem including an electrostatic drive and torsion spring suspension. This may exemplarily be a one-dimensional torsion-vibratable element, like, for example, a one-dimensional micromirror, a two-dimensional torsion-vibratable element, like, for example, a two-dimensional micromirror, but also a translation-vibratable element, like, for example, a resonant lowerable mirror including a suspension consisting of torsion spring elements, as is, for example, illustrated by Drabe and others in “A large deflection translatory actuator for optical path length modulation”, Proc. SPIE Vol. 6.186, 618.604, Apr. 21, 2006. Introducing the non-rigid biased suspension may in these devices result in an increase in the electromechanical stability and in an improvement and/or influence of the mode splitting in the respective device.

A non-rigid biased suspension here may exemplarily be intended to be a bendable and/or deformable biased suspension, but may, for example, also be springs, torsion springs, bending springs or other non-rigid connections.

As has been shown in the embodiments explained before, biasing the non-rigid suspension by compressive stress, tensile stress or a stress gradient, by intrinsic mechanical stress or a combination of the methods for generating a tensile stress within the suspension may be employed for increasing the rigidity of the micromechanical device.

However, it is also conceivable, as described before, that the suspension biasing is performed by a micromechanical drive additionally installed in the device or also an external additional micromechanical drive.

It is also conceivable that the casing of the micromechanical device is used for biasing the non-rigid suspension, on the one hand by intrinsic stress generated within the casing, but also by an actor which is within the casing and exemplarily operates in accordance with a piezoelectric effect, a thermal effect, a magnetic effect or any other physical-chemical effect and applies a force on the non-rigid suspension for biasing same.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A micromechanical device comprising:
a deflectable micromechanical functional structure; and
a non-rigid biased suspension positioning the micromechanical functional structure in the micromechanical device.

2. The micromechanical device of claim 1, wherein the deflectable micromechanical functional structure comprises a first comb electrode, the micromechanical device including a second comb electrode, and the non-rigid biased suspension positioning the first comb electrode relative to the second comb electrode.

3. The micromechanical device of claim 1, wherein the deflectable micromechanical functional structure is a one- or two-dimensional deflectable torsion-vibratable element.

4. The micromechanical device of claim 1, wherein the deflectable micromechanical functional structure is a translation-vibratable element.

5. The micromechanical device of claim 1, wherein the non-rigid biased suspension is biased by intrinsic stress in the suspension.

6. The micromechanical device of claim 1, wherein the non-rigid biased suspension is biased by the action of an external force.

7. The micromechanical device of claim 1, comprising a structure biasing the non-rigid suspension.

8. The micromechanical device of claim 7, wherein the structure applies compressive and/or tensile stress to the non-rigid suspension.

9. The micromechanical device of claim 8, wherein the structure defines an internal stress gradient in order to apply compressive and/or tensile stress to the non-rigid suspension.

10. The micromechanical device of claim 1, wherein the micromechanical functional structure comprises intrinsic stress which applies compressive and/or tensile stress to the non-rigid suspension for biasing same.

11. The micromechanical device of claim 1, comprising a casing to which the non-rigid suspension is mounted.

12. The micromechanical device of claim 11, comprising an actor arranged in the casing, the actor being operative to bias the non-rigid suspension.

13. The micromechanical device of claim 12, wherein the actor operates in accordance with the piezoelectric, thermal, electrostatic, magnetorestrictive principle or another physical-chemical principle.

14. The micromechanical device of claim 1, wherein the micromechanical device is a microsystem operated in resonance including an electrostatic drive and torsion spring suspension.

15. The micromechanical device of claim 1, wherein the micromechanical device is a microsystem operated quasi-statically including an electrostatic drive and torsion spring suspension.

16. The micromechanical device of claim 1, wherein the non-rigid biased suspension is a torsion or bending spring.
